(19) United States
(12) Patent Application Publication
(10) Pub. No.: US 2022/0198339 A1
(43) Pub. Date: Jun. 23, 2022

(54) SYSTEMS AND METHODS FOR TRAINING MACHINE LEARNING MODEL BASED ON CROSS-DOMAIN DATA

(71) Applicant: BEIJING DIDI INFINITY TECHNOLOGY AND DEVELOPMENT CO., LTD., Beijing (CN)

(72) Inventors: Zhen ZHAO, Beijing (CN); Yuhong GUO, Toronto (CA)

(73) Assignee: BEIJING DIDI INFINITY TECHNOLOGY AND DEVELOPMENT CO., LTD., Beijing (CN)

(21) Appl. No.: 17/131,790

(22) Filed: Dec. 23, 2020

(51) Int. Cl. G06N 20/20; G06N 3/08; G06K 9/62

(52) U.S. Cl. CPC G06N 20/20; G06N 3/08; G06K 9/6256; G06K 9/6232; G06K 9/6268

(57) ABSTRACT

Systems and methods for training an initial machine learning model is provided. The system may train an initial machine learning model using source domain training data with sample labels and target domain training data without sample labels. The initial machine learning model may include a feature extraction unit, a first processing unit, and an adversarial unit, wherein the first processing unit is associated with a first loss function, and the adversarial unit is associated with a second loss function. In some embodiments, the initial machine learning model may also include a second processing unit. A third loss function that reflects the consistency of the first processing unit and the second processing unit may be determined. The initial machine learning model may be trained based on the feature extraction unit, the first processing unit, the adversarial unit, and the second processing unit.

### TECHNICAL FIELD

The present disclosure generally relates to training a model, and more particularly, relates to systems and methods for training a machine learning model based on cross-domain data.

### BACKGROUND

Deep learning models are widely used in tasks such as image classification, image segmentation, object detection, and semantic recognition. Generally, to train such a model, a sufficient amount of labeled data is needed, and the training data and the test data need to come from the same data source and distribution. However, in practical applications, the training and test data (e.g., images, texts) sometimes come from different domains that exhibit apparent deviations. For example, the training data may be cartoons (e.g., of a source domain), and the test data may be actual photographs (e.g., of a target domain). Consequently, such a trained model (e.g., trained using cartoons) is used to detect images in different domains (e.g., the actual photographs), the detection performance of the trained model drops sharply. Thus, it is desirable to develop systems and methods for training a machine learning model based on cross-domain data to achieve unsupervised cross-domain detection.

### SUMMARY

According to an aspect of the present disclosure, a system is provided. The system may include at least one storage device storing executable instructions for training an initial machine learning model, and at least one processor in communication with the at least one storage device, when executing the executable instructions, causing the system to perform operations including: obtaining multiple source domain training samples and multiple target domain training samples, wherein the multiple source domain training samples include multiple sample labels; obtaining the initial machine learning model that includes a feature extraction unit, a first processing unit, and an adversarial unit, wherein the first processing unit is associated with a first loss function, and the adversarial unit is associated with a second loss function; and generating, based on a total loss function relating to the first loss function and the second loss function, a trained machine learning model by training the initial machine learning model using the multiple source domain training samples and the multiple target domain training samples, wherein during the training, the feature extraction unit extracts a plurality of source features of the multiple source domain training samples and a plurality of target features of the multiple target domain training samples; the first processing unit determines multiple first source prediction outputs based on the plurality of source features and determines multiple first target prediction outputs based on the plurality of target features, wherein the multiple first source prediction outputs and the multiple sample labels are used to determine the first loss function; and the adversarial unit determines multiple source prediction domains based on the plurality of source features and determines multiple target prediction domains based on the plurality of target features, wherein the multiple source prediction domains, domain labels of the multiple source domain training samples, the multiple target prediction domains, and domain labels of the multiple target domain training samples are used to determine the second loss function.

In some embodiments, the initial machine learning model may further include a second processing unit. During the training, the second processing unit may determine multiple second source prediction outputs based on the plurality of source features and determine multiple second target prediction outputs based on the plurality of target features. The multiple first source prediction outputs, the multiple first target prediction outputs, the multiple second source prediction outputs, and the multiple second target prediction outputs may be used to determine a third loss function that reflects a consistency of the first processing unit and the second processing unit. The system may train the initial machine learning model based on the third loss function.

In some embodiments, the multiple source domain training samples and the multiple target domain training samples may be images. The second processing unit may include a region convolutional neural network (RCNN) that determines a category of each object included in the images.

In some embodiments, the RCNN may include a classification end that determines a position of each object in the images and a regression end that determines a category of each object in the images. The regression end may relate to a regression loss function, and the classification end may relate to a classification loss function. The regression loss function and the classification loss function may be used to determine a fourth loss function. The system may train the initial machine learning model based on the fourth loss function.

In some embodiments, to determine, based on the multiple first source prediction outputs, the multiple first target prediction outputs, the multiple second source prediction outputs, and the multiple second target prediction outputs, the third loss function, the at least one processor is further configured to cause the system to perform operations including determining, based on the multiple first source prediction outputs and the multiple second source prediction outputs, a source divergence loss function; determining, based on the multiple first target prediction outputs and the multiple second target prediction outputs, a target divergence loss function; and determining, based on the source divergence loss function and the target divergence loss function, the third loss function.

In some embodiments, the multiple source domain training samples and the multiple target domain training samples may be images. During the training, the feature extraction unit may extract the plurality of source features and the plurality of target features based on the multiple source domain training samples and the multiple target domain training samples according to a convolutional network.

In some embodiments, the first processing unit may determine a category of each object included in the images. The first processing unit may include a multi-label classifier having one or more label prediction output ends each of which corresponds to one category.

In some embodiments, the multiple target domain training samples and the multiple source domain training samples may be text data. During the training, the feature extraction unit may extract the plurality of source features and the plurality of target features based on the multiple source domain training samples and the multiple target domain training samples according to a language model. The first processing unit may determine at least a semantic category included in the text data.

In some embodiments, the adversarial unit may include a feature processing sub-unit configured to determine multiple source sub-features by processing the plurality of source features, and determine multiple target sub-features by processing the plurality of target features; a connection sub-unit configured to determine multiple source outputs based on the multiple source sub-features and the multiple first source prediction outputs, and determine multiple target outputs based on the multiple target sub-features and the multiple first target prediction outputs; and a prediction layer configured to generate multiple prediction results based on the multiple source outputs and the multiple target outputs.

According to another aspect of the present disclosure, a method is provided. The method may include obtaining multiple source domain training samples and multiple target domain training samples, wherein the multiple source domain training samples include multiple sample labels; obtaining the initial machine learning model that includes a feature extraction unit, a first processing unit, and an adversarial unit, wherein the first processing unit is associated with a first loss function, and the adversarial unit is associated with a second loss function; and generating, based on a total loss function relating to the first loss function and the second loss function, a trained machine learning model by training the initial machine learning model using the multiple source domain training samples and the multiple target domain training samples, wherein during the training, the feature extraction unit extracts a plurality of source features of the multiple source domain training samples and a plurality of target features of the multiple target domain training samples; the first processing unit determines multiple first source prediction outputs based on the plurality of source features and determines multiple first target prediction outputs based on the plurality of target features, wherein the multiple first source prediction outputs and the multiple sample labels are used to determine the first loss function; and the adversarial unit determines multiple source prediction domains based on the plurality of source features and determines multiple target prediction domains based on the plurality of target features, wherein the multiple source prediction domains, domain labels of the multiple source domain training samples, the multiple target prediction domains, and domain labels of the multiple target domain training samples are used to determine the second loss function.

According to yet another aspect of the present disclosure, a non-transitory computer readable medium is provided, comprising at least one set of instructions, wherein when executed by at least one processor of a computing device, the at least one set of instructions direct the at least one processor to perform operations. The operations may include obtaining multiple source domain training samples and multiple target domain training samples, wherein the multiple source domain training samples include multiple sample labels; obtaining the initial machine learning model that includes a feature extraction unit, a first processing unit, and an adversarial unit, wherein the first processing unit is associated with a first loss function, and the adversarial unit is associated with a second loss function; and generating, based on a total loss function relating to the first loss function and the second loss function, a trained machine learning model by training the initial machine learning model using the multiple source domain training samples and the multiple target domain training samples, wherein during the training, the feature extraction unit extracts a plurality of source features of the multiple source domain training samples and a plurality of target features of the multiple target domain training samples; the first processing unit determines multiple first source prediction outputs based on the plurality of source features and determines multiple first target prediction outputs based on the plurality of target features, wherein the multiple first source prediction outputs and the multiple sample labels are used to determine the first loss function; and the adversarial unit determines multiple source prediction domains based on the plurality of source features and determines multiple target prediction domains based on the plurality of target features, wherein the multiple source prediction domains, domain labels of the multiple source domain training samples, the multiple target prediction domains, and domain labels of the multiple target domain training samples are used to determine the second loss function.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary application scenario of a machine learning model training system based on cross-domain data according to some embodiments of the present disclosure;

FIG. 2 is a flowchart illustrating an exemplary process for training a training model according to some embodiments of the present disclosure;

FIG. 3 is a flowchart illustrating an exemplary process for training a training model according to some embodiments of the present disclosure;

FIG. 4 is a flowchart illustrating an exemplary process of training a training model when the source domain training data and the target domain training data are images according to some embodiments of the present disclosure;

FIG. 5 is a flowchart illustrating an exemplary process for training a training model according to some embodiments of the present disclosure; and

FIG. 6 is a flowchart illustrating an exemplary process for training a training model according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections, or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The present disclosure provides systems and methods for training an initial machine learning model based on cross-domain data. The system may train an initial machine learning model using source domain training data with sample labels and target domain training data without sample labels. The initial machine learning model may include a feature extraction unit, a first processing unit, and an adversarial unit, wherein the first processing unit is associated with a first loss function, and the adversarial unit is associated with a second loss function. Accordingly, according to the training system, when the target domain data lacks sufficient sample labels, a model with strong predictive ability for the target domain can be trained using the labeled sample data in the source domain and the unlabeled sample data in the target domain.

In some embodiments, the initial machine learning model may also include a second processing unit. A third loss function that reflects the consistency of the first processing unit and the second processing unit may be determined. The initial machine learning model may be trained based on the feature extraction unit, the first processing unit, the adversarial unit, and the second processing unit. During the training, the feature extraction unit may be trained to extract the commonalities of different domains as much as possible when extracting features to reduce the influence of differences between domains. Therefore, the trained model may be difficult to distinguish whether the features come from the source domain or the target domain, that is, the features can still be extracted by the feature extraction unit regardless of whether the feature is previously labeled. As a result, during the prediction, the trained model may output accurately prediction results for data in the target domain. Optionally, during the training of the initial machine learning model, the second processing unit may learn characteristics of the first processing unit and the adversarial unit. Therefore, in some embodiments, the trained model may just include the trained feature extraction unit and the trained second processing unit.

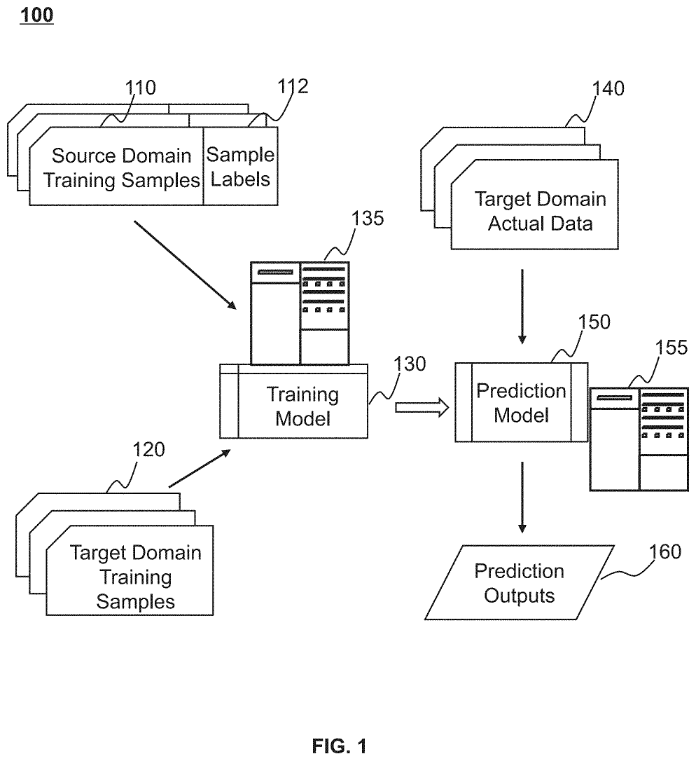

FIG. 1 is a schematic diagram illustrating an exemplary application scenario of a machine learning model training system (“training system” for brevity) based on cross-domain data according to some embodiments of the present disclosure. As shown in FIG. 1, an application scenario 100 may involve a first computing device 135 and a second computing device 155. The first computing device 135 may include a training model 130 (e.g., an initial machine learning model), and the second computing device 155 may include a prediction model 150 (e.g., a trained machine learning model).

The first computing device 135 may be configured to train the training model 130 (i.e., the initial machine learning model) based on a plurality of training data. The plurality of training data may include multiple source domain training samples 110 with multiple sample labels 112 and multiple target domain training samples 120 without sample labels. Each of the multiple source domain training samples 110 and the multiple target domain training samples 120 may include a domain label. The second computing device 155 may be configured to obtain target domain actual data 140, and generate one or more prediction results 160 based on the target domain actual data 140 by using the prediction model 150.

The training model 130 and/or the prediction model 150 may be a collection of multiple methods performed by a processing device. The multiple methods may include a plurality of parameters. In some embodiments, when training the training model 130 or executing the prediction model, the plurality of parameters may be preset or dynamically adjusted. For example, a portion of the plurality of parameters of the prediction model 150 may be obtained from a trained training model 130 by performing a training process, and a portion of the plurality of parameters may be obtained during execution. More descriptions of the models may be found elsewhere in the present disclosure.

As used herein, the first computing device 135 or the second computing device 155 refers to a system with processing capabilities, which may include various computing devices, such as a server, a personal computer (PC), or a computing platform composed of multiple computers connected in various ways. In some embodiments, the first computing device 135 and the second computing device 155 may be the same or different. In some embodiments, the first computing device 135 and the second computing device 155 may be integrated into one computing device.

The first computing device 135 or the second computing device 155 may include a processing device which can execute computer instructions (e.g., program code). In some embodiments, the processing device may include one or more hardware processors, such as a microcontroller, a microprocessor, a reduced instruction set computer (RISC), application-specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

In some embodiments, the first computing device 135 and/or the second computing device 155 may include a storage device that can store instructions, data, and/or any other information. In some embodiments, the storage device 150 may include a mass storage device, a removable storage device, a volatile read-and-write memory, a read-only memory (ROM), or the like, or any combination thereof.

In some embodiments, the first computing device 135 and/or the second computing device 155 may include a network for internal connection and external connection, and/or a terminal device for data input or data output. In some embodiments, the network may include a wired network and/or a wireless network.

It should be understood that the training system and/or any component thereof can be implemented in various ways. For example, in some embodiments, the system and the component thereof may be implemented as hardware, software, or a combination of software and hardware. The hardware may be implemented using dedicated logics. The software may be stored in a memory and executed by an appropriate instruction execution device, such as a microprocessor, a dedicated design hardware, etc. Those skilled in the art should understand that the above-mentioned methods and systems can be implemented using computer-executable instructions and/or control codes contained in a processor. For example, the control codes may be provided on a carrier medium (e.g., a disk, a CD, or a DVD-ROM), a programmable ROM (PROM), a data carrier such as an optical or electronic signal carrier, etc. In some embodiments, the training system and the component thereof described in the present disclosure may be implemented by semiconductors (e.g., very large scale integrated circuits or gate arrays, logic chips, transistors, etc.), hardware circuits of a programmable hardware device (e.g., a field programmable gate array (FPGA), a programmable logic device (PLD), etc.), a software executed by various types of processors, a combination of the hardware circuit and a software (e.g., firmware), etc.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

In some embodiments, for a situation that manually labeling features in a large amount of data can result in high cost and time-consuming, data in a first domain with features that are labeled can be used as the source domain data, and data in a second domain that is different from the first domain with features that are unlabeled can be used as the target domain data. As a result, the problem of manual labeling may be solved through feature cross-domain training described in the present disclosure.

In some embodiments, feature cross-domain transfer learning may transfer features in the pixel-level (e.g., when the training data is image data), which can be used for object detection in images. However, the feature transfer in the pixel-level may be prone to generate chaotic images, which have a negative impact on the training and cause unnecessary consumption of computational resource and time.

In some other embodiments, feature cross-domain transfer learning may be realized by learning a domain discriminator by minimizing the domain classification error that distinguishes source domain features from target domain features. However, in such cases, it only realizes the alignment of domain features of the two domains, but does not realize the alignment of sample labels (that is, ignores the correlation between the features and categories). When the data contains multi-category features, the previous adversarial transfer cannot capture such multi-category features, which easily produce negative transfer effects. Thus, in some embodiments, a machine learning model training system based on cross-domain data may be provided, which reduces the complexity of calculation through feature transformation in the deep network and improves the detection performance in the target domain by designing a multi-label classifier to predict the probability of the global category.

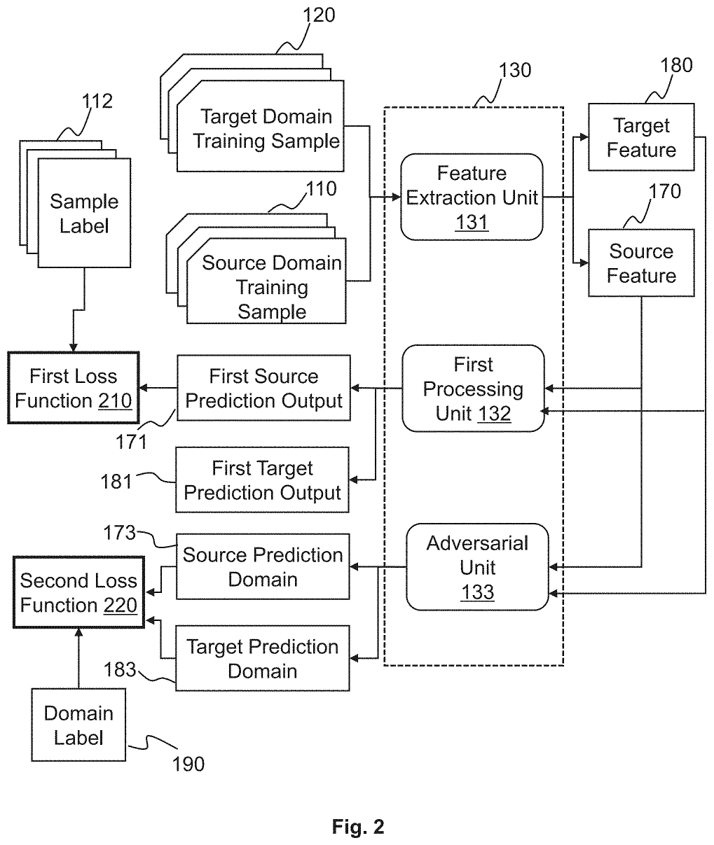

FIG. 2 is a flowchart illustrating an exemplary process for training a training model according to some embodiments of the present disclosure. A trained model (e.g., the prediction model 150 described in FIG. 1) may be generated by training the training model 130 based on a plurality of training data. One or more parameters of the training model 130 may be updated during the training.

As shown in FIG. 2, the training model 130 may include a feature extraction unit 131, a first processing unit 132, and an adversarial unit 133. The input of the training model 130 may include multiple source domain training samples 110 (or source domain training data) and multiple target domain training samples 120 (or target domain training data), and the output of the training model 130 may include source prediction domains 173 of the multiple source domain training samples 110 and target prediction domains 183 of the multiple target domain training samples 120. The multiple source domain training samples 110 may include training data with sample labels 112, and the multiple target domain training samples 120 may include training data without sample labels 112. The multiple source domain training samples 110 may be training data in a source domain and the multiple target domain training samples 120 may be training data in a target domain. Each of the multiple source domain training samples 110 and multiple target domain training samples 120 may include a domain label. For example, when the multiple source domain training samples 110 are cartoons and the multiple target domain training samples 120 are photos, the domain label of each of the multiple source domain training samples 110 may be labeled as 1 which indicates a generated image, and the domain label of each of the multiple target domain training samples 120 may be labeled as 0 which indicates an actual image.

As used herein, a source domain and a target domain refer to two similar but different domains of data. In some embodiments, the source domain training samples 110 may include data from a virtual scene (e.g., generated data), and the target domain training samples 120 may include data from a real scene. In some alternative embodiments, the source domain training samples 110 may include data from a real scene, and the target domain training samples 120 may include data from a virtual scene (e.g., generated data). For example, for image data (e.g., training data of the training model 130), the domain of data in the source domain (e.g., the multiple source domain training samples 110) may be cartoons, and the domain of data in the target domain (e.g., the multiple target domain training samples 120) may be photos, wherein the cartoons in the source domain and the photos in the target domain have one or more similar features, such as both the photos and the cartoons include human beings, cars, birds, etc.

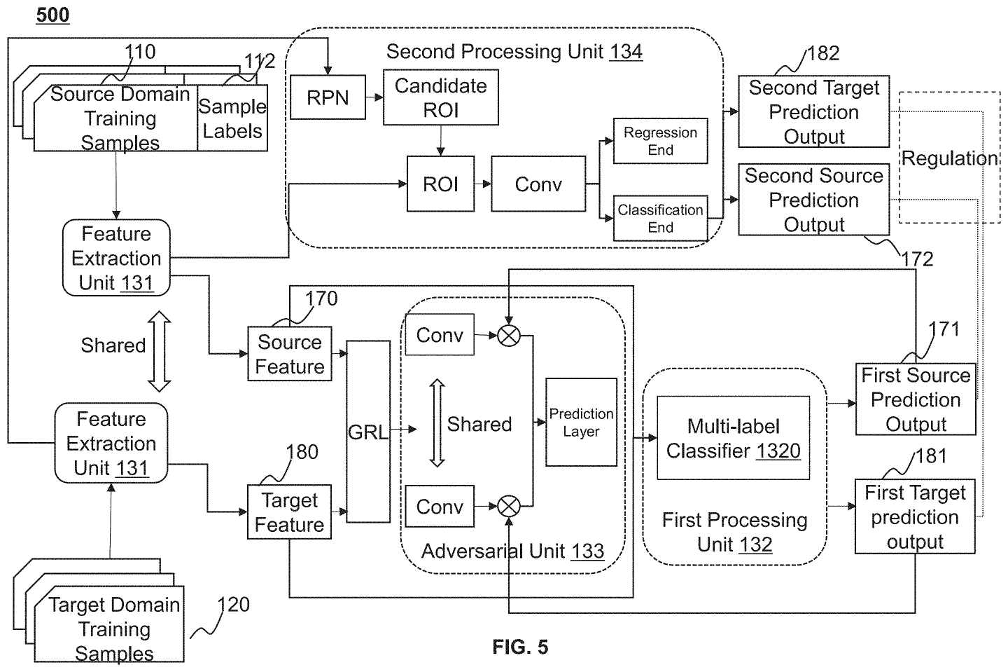

Merely by way of example, the multiple source domain training samples 110 and the multiple target domain training samples 120 may be images (i.e., source domain images and target domain images). The sample labels of the multiple source domain training samples 110 may include a category of each object (e.g., a human, an animal, a car) in the source domain images. For example, a certain source domain image may include a human and a car but not an animal, the sample label 112 of the certain source domain image may be represented by a vector such as (1, 0, 1). In some embodiments, the multiple source domain training samples 110 and the target domain training samples 120 may also be text data. The sample labels of the multiple source domain training samples 110 may include semantic categories. More descriptions about the current system and method when the training data is text data may be found elsewhere in the present disclosure (e.g., FIG. 5 and the descriptions thereof). In some embodiments, the data of the target domain and the source domain may also be other types of data, such as audio data (e.g., voice data).

In some embodiments, the feature extraction unit 131 may extract a plurality of source features 170 of the multiple source domain training samples 110 and a plurality of target features 180 of the multiple target domain training samples 120. In some embodiments, the source features 170 and/or the target features 180 may be represented by matrixes, vectors, values, etc. In some embodiments, when the multiple source domain training samples 110 and the multiple target domain training samples 120 are images, the feature extraction unit 131 may include a residual network (e.g., the ResNet50, the ResNet101, etc.). That is, the residual network may be used to extract the source features 170 and the target features 180. In some embodiments, when the multiple source domain training samples 110 and the multiple target domain training samples 120 are text data, the feature extraction unit 131 may include a text analysis model (e.g., the Word2vec, the Doc2vec, etc.).

After the feature extraction unit 131 extracts the source features 170 and the target sources 180, a processing device may determine prediction results based on the features (e.g., the source features 170 and/or the target sources 180) such as determining categories of the features. In some embodiments, the first processing unit 132 may determine multiple first source prediction outputs 171 based on the source features 170, and determine multiple first target prediction outputs 181 based on the target features 180.

In some embodiments, the first processing unit 132 may include a classification model. The source features 170 and the target sources 180 may be inputted into the classification model, which may generate the first source prediction outputs 171 that indicate feature classification results of the source features 170 and the first target prediction outputs 181 that indicate feature classification results of the target features 180. In some embodiments, the first source prediction outputs 171 and the first target prediction outputs 181 generated by the first processing unit 132 may be represented by probability values each of which corresponds to a prediction category. In some embodiments, the first processing unit 132 may include a linear regression model, a neural network, or the like, or any combination thereof.

In some embodiments, a first loss function 210 may be determined based on the first source prediction outputs 171 and the multiple sample labels 112. In some embodiments, when the first processing unit 132 is a classification model, the first loss function 210 may be determined as Equation (1) as follows:

$${L}_{mutil} = \frac{1}{{n}_{s}} {\sum }_{i = 1}^{{n}_{s}} {y}_{i}^{{s}^{T}} log ( {p}_{i}^{s} ) + {( 1 - {y}_{i}^{s} )}^{T} log ( 1 - {p}_{i}^{2} ) \qquad ( 1 )$$

where nₛ denotes a sample count of the multiple source domain training samples 110, yₛⁱ denotes a sample label 112 of the i-th source domain training sample 110, pₛⁱ denotes the i-th first source prediction output(s) 171, and T denotes vector transpose.

The adversarial unit 133 may determine multiple source prediction domains 173 based on the source features 170, and multiple target prediction domains 183 based on the target features 180. A second loss function 220 may be determined based on the multiple source prediction domains 173, the multiple target prediction domains 183, and the domain labels 190 (including domain labels of the multiple source domain training samples 110 and domain labels of the multiple target domain training samples 120).

As used herein, a domain label refers to a label used to indicate the domain of each of the training samples inputted into the training model 130. For example, the domain labels of the source domain training samples 110 may be labeled as 1, and the domain labels of the target domain training samples 120 may be labeled as 0. A source prediction domain refers to a predicted result indicating to which domain (e.g., the source domain or the target domain) the corresponding source features belong. A target prediction domain refers to a predicted result indicating to which domain the corresponding target features belong. The adversarial unit 133 may determine which domain the source domain training samples belong to and which domain the target domain training samples belong to.

After the source features 170 and the target features 180 are inputted in the adversarial unit 133, predicted results reflecting a result of distinguishing the two domains may be generated. By constructing the second loss function 220 to obfuscate the adversarial unit 133, the alignment of cross-domain features in the source domain training samples 110 and the target domain training samples 120 may be realized, thereby bridging the domain distribution gaps while preserving the discriminability of the features. Merely by way of example, the source domain training data 110 may be acquired from real scenes such as photos containing birds, the target domain training data 120 may be cartoons containing birds. Thus, the training data (including the source domain training data 110 and the target domain training data 120) from different domains may include the same category features (i.e., both the source domain training data 110 and the target domain training data 120 include birds). Visually, the appearances of the source domain training data and the target domain training data is different, but the alignment of the features of the training data in the two domains may be realized. As used herein, the term “alignment” refers to making features of similar data from different domains close.

In some embodiments, the second loss function 220 may be generated by comparing the outputs of the adversarial unit 133 with the domain labels 190. For instance, the value of a specific source prediction domain of a specific source domain training sample may be 0.8, and the domain label of the specific source domain training sample may be 1. Thus, the value of the specific source prediction domain of the specific source domain training sample can be close to 1 by optimizing (e.g., adjusting one or more parameters) the adversarial unit 133 using the second loss function 220. In some embodiments, the second loss function 220 may use but not limited to Square Loss, Absolute Loss, etc.

In some embodiments, for the source prediction domains 173 and the target prediction domains 183, a source domain loss function and a target domain loss function may be constructed, respectively. The second loss function 220 may be determined by the source domain loss function and the target domain loss function to optimize the adversarial unit 133, for example, taking a sum of the source domain loss function and the target domain loss function as the second loss function 220.

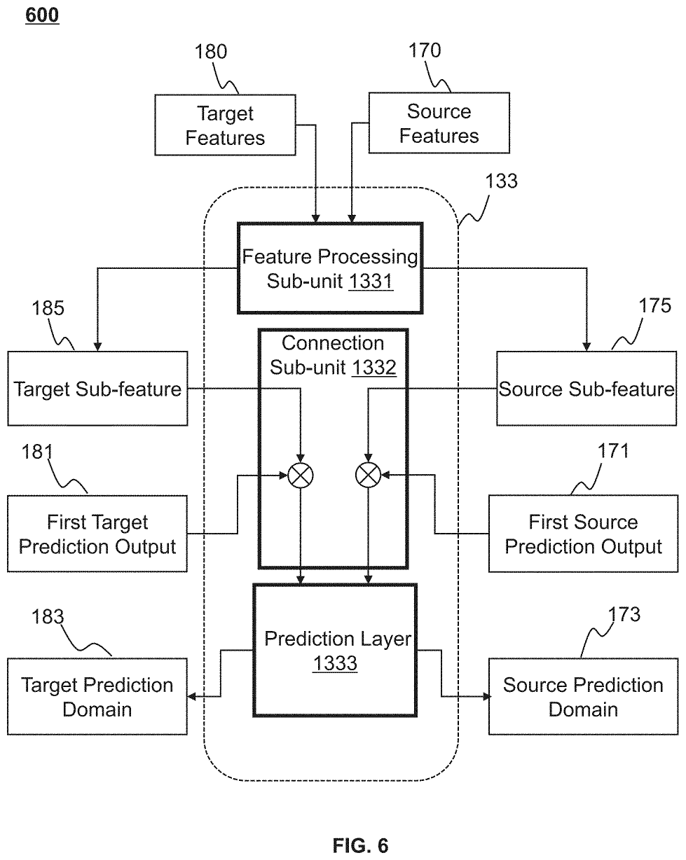

More descriptions about the determining the second loss function based on the source domain loss function and the target domain loss function may be found elsewhere in the present disclosure (e.g., FIG. 6 and the descriptions thereof).

In some embodiments, the adversarial unit 133 may include a neural network model. In other embodiments, the adversarial unit 133 may be other classification models, such as a gradient boosting decision tree (GBDT), a support vector machine (SVM), etc. In some embodiments, the adversarial unit 133 may include an activation function, such as a sigmoid function, a softmax activation function, etc. More descriptions about the adversarial unit 133 may be found elsewhere in the present disclosure (e.g., FIG. 6 and the descriptions thereof).

In some embodiments, the training model 130 may be trained based on the first loss function 210 and the second loss function 220. That is, a total loss function of the training model 130 may be determined based on the first loss function 210 and the second loss function 220. For example, the total loss function of the training model 130 may be a sum of the two loss functions (i.e., the first loss function 210 and the second loss function 220). As another example, the two loss functions may be assigned weights, and the total loss function of the training model 130 may be determined based on the weights. In some embodiments, the weights of the two loss functions may be preset (e.g., by a user via a terminal device) to reflect the importance of the first processing unit 132 and the adversarial unit 133 during the training.

According to some embodiments of the present disclosure, the training model 130, including the feature extraction unit 131, the first processing unit 132, and the adversarial unit 133, may be trained based on the source domain training data 110, the target domain training data 120, the sample labels 112 of the source domain training data 110, and the domain labels 190. A trained model may be generated by updating one or more parameters of the training model 130 to make the source prediction domains 173 output by the trained model approach the target prediction domains 183, enable the feature extraction unit 131 to obtain the commonalities of different domains as much as possible when extracting features, and reduce the influence of differences between domains. As a result, the total loss function of the training model 130 may include both the loss function between the sample labels 112 and the prediction outputs of the training data, and the loss function between the domain labels 190 and the prediction domains of the training data, which are optimized during the training.

Further, by training the model in the above described manner, the features of the two domains (i.e., the source domain and the target domain) may be aligned while the labels are also aligned, which take into account the correlation between the features and categories, and improve the detection performance of the trained model. By optimizing the second loss function 220, the features extracted by the feature extraction unit 131 can reflect the commonality of the data of the two domains, thereby reducing the influence of the differences in different domains.

Further, since both the first processing unit 132 and the second processing unit 134 can output source prediction outputs based on source features extracted by the features extraction unit, and the source features and the target features extracted by the features extraction unit may have strong domain commonalities, the updated first processing unit and the updated second processing unit of the trained model may output accurate prediction results for the data in the target domain. In this way, when the target domain data lacks sufficient sample labels, a model with strong predictive ability for the target domain can be trained using the labeled sample data in the source domain and the unlabeled sample data in the target domain.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, during the training, an optimization algorithm of the training model may include a gradient descent algorithm, a conjugate gradient algorithm, a Newton's method & Quasi-Newton Method, or the like. In some embodiments, the trained model can be used to predict data of the target domain. The data used in prediction may be different from the data used during the training. The prediction may be performed based on an updated feature extraction unit and an updated first processing unit of the trained model.

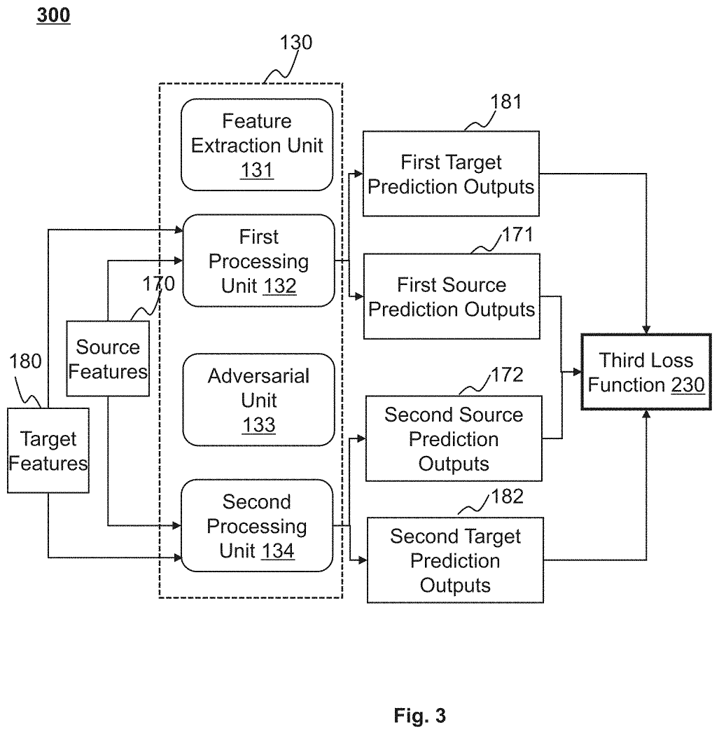

FIG. 3 is a flowchart illustrating an exemplary process for training a training model according to some embodiments of the present disclosure.

In some embodiments, the training model 130 may further include a second processing unit 134. The second processing unit 134 may determine multiple second source prediction outputs 172 based on the plurality of source features 170 and determine multiple second target prediction outputs 182 based on the plurality of target features 180.

In some embodiments, the second source prediction outputs 172 and the second target prediction outputs 182 that output from the second processing unit 134 may include classification results of features in the source domain and the target domain. In some embodiments, the multiple second source prediction outputs 172 and the multiple second target prediction outputs 182 may be represented by probability values.

In some embodiments, the second processing unit 134 may include a convolutional neural network (CNN) model. In some embodiments, the second processing unit 134 may other models, such as a region convolutional neural network (RCNN). More descriptions about the second processing unit 134 may be found elsewhere in the present disclosure (e.g., FIG. 5 and the descriptions thereof).

In some embodiments, a third loss function 230 may be constructed based on the first processing unit 132 and the second processing unit 134. In some embodiments, the multiple first source prediction outputs 171, the multiple first target prediction outputs 181, the multiple second source prediction outputs 172, and the multiple second target prediction outputs 182 may be used to determine the third loss function 230. The third loss function 230 may reflect a consistency of the first processing unit 132 and the second processing unit 134. Thus, by adjusting one or more parameters of the training model 130 to reduce the third loss function 230, a difference between the first processing unit 132 and the second processing unit 134 may be reduced. In other words, auxiliary regularization information may be induced in the training to ensure consistency between the first processing unit 132 and the second processing unit 134.

In some embodiments, the first source prediction outputs 171 and the second source prediction outputs 172 may be used to determine a loss function Lₖₗ^{s}. Lₖₗ^{s} may reflect differences between the first source prediction outputs 171 and the second source prediction outputs 172. The first target prediction outputs 181 and the second target prediction outputs 182 may be used to determine a loss function Lₖₗ^{t}. Lₖₗ^{t} may reflect differences between the first target prediction outputs 181 and the second target prediction outputs 182. The third loss function 230 may be determined based on the loss function Lₖₗ^{s} and the loss function Lₖₗ^{t}. For example, the third loss function 230 may be determined based on a sum of the loss function Lₖₗ^{s} and the loss function Lₖₗ^{t}, which may be represented as Equation (2):

Lₖₗ=Lₖₗ^{s}+Lₖₗ^{t} (2)

In some embodiments, the loss function Lₖₗ^{s} and the loss function Lₖₗ^{t} may be assigned weights, and the third loss function may be determined based on the weights. In some embodiments, the weights of the two loss functions may be preset (e.g., by a user via a terminal device) to reflect the importance of the second source prediction outputs 172 and the second target prediction outputs 182 during the training.

In some embodiments, the training model 130 may be trained based on the first loss function 210, the second loss function 220, and the third loss function 230.

In some embodiments, the training model 130 may also be trained based on a fourth loss function that is generated based on the training data and the second prediction outputs. For example, the loss function of the training model 130 may be a sum of the first loss function 210, the second loss function 220, the third loss function 230, and the fourth loss function. More descriptions about the fourth loss function may be found elsewhere in the present disclosure (e.g., FIG. 5 and the descriptions thereof).

According to some embodiments of the present disclosure, the training model 130, including the feature extraction unit 131, the first processing unit 132, the adversarial unit 133, and the second processing unit 134, may be trained based on the first source prediction outputs 171, the second source prediction outputs 172, the first target prediction outputs 181, the second target prediction outputs 182. A trained model may be generated by updating one or more parameters of the training model 130 to make the source prediction domains 173 output by the trained model approach the target prediction domains 183, and make the outputs of the first processing unit 132 and the outputs of the second processing unit 134 approach each other. During the training, an optimization algorithm of the training model may include a gradient descent algorithm, a conjugate gradient algorithm, a Newton's method & Quasi-Newton Method, or the like.

It should be noted that by training the training model 130 in the above described manner, the third loss function 230 may include both the loss function between the first source prediction outputs 171 and the second source prediction outputs 172, and the loss function between the first target prediction outputs 181 and the second target prediction outputs 182, which are optimized during the training. By optimizing the third loss function 230, based on input features, the outputs of the first processing unit 132 and the outputs of the second processing unit 134 approach each other.

The trained model may be used to predict data of the target domain. The data used in prediction can be different from the data used in training. In some embodiments, the prediction may be performed based on an updated feature extraction unit, an updated first processing unit, and an updated second processing unit of the trained model, for example, the prediction results of the updated first processing unit and the updated second processing unit are averaged, weighted averaged, and so on. In some embodiments, since the second processing unit 134 learns the output characteristics of the first processing unit 132 during the training, the prediction can be performed based on the updated feature extraction unit and the updated second processing unit without the updated first processing unit.

Further, the updated second processing unit may have stronger functions than the updated first processing unit, and better prediction results may be obtained by using the updated second processing unit. In addition, because the first processing unit 132 is used to participate in the joint training with the second processing unit 134, the second processing unit 134 may be assisted to obtain better training results.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

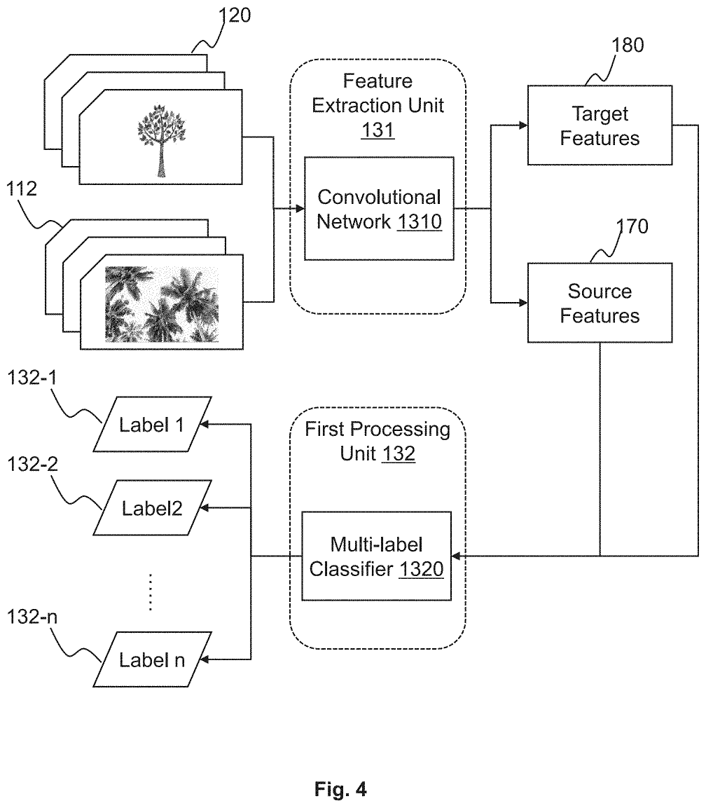

FIG. 4 is a flowchart illustrating an exemplary process of training a training model when the source domain training data and the target domain training data are images according to some embodiments of the present disclosure.

In some embodiments, the source domain training samples 110 and the target domain training samples 120 may be images. The source domain training samples 110 may include sample labels 112. For example, the source domain training samples 110 may include the PASCAL VOC data sets, wherein the sample labels 112 may include categories such as car, cat, dog, human, bird, etc. The target domain training samples 120 may include watercolors and/or cartoon paintings of the watercolor2K and/or comic2K data sets.

It should be noted that the use of the watercolor2K and/or comic2K data sets as target training data is to train the training model 130. After the training model 130 is trained, and in practical applications, data of target domain can be actual data, such as photos and surveillance videos. More descriptions regarding the execution or use of the trained model may be found elsewhere in the present disclosure (e.g., FIG. 6 and the descriptions thereof).

In some embodiments, the feature extraction unit 131 may include a convolutional network 1310. The convolutional network 1310 may perform a convolutional operation on the source domain training samples 110 and the target domain training samples 120 to obtain the source features 170 and the target features 180. For example, the feature extraction unit 131 may include multiple convolutional networks of the Resnet101 network.

In some embodiments, the first processing unit 132 may determine a category of each object included in the images. In some embodiments, the category of each object included in the images may be represented by a probability value. The first processing unit 132 may include a multi-label classifier 1320 having one or more label prediction output ends each of which corresponds to one object category.

In some embodiments, the multi-label classifier 1320 may include a neural network model, the output layer of the neural network model may be provided with multiple output ends each of which corresponds to an object category. In some embodiments, the multi-label classifier 1320 may include multiple linear regression models each of which includes an output end. In some embodiments, the multi-label classifier 1320 may be the output layer of the neural network model, which has multiple output ends.

In some embodiments, for the input features (i.e., the source features 170 and the target features 180), each output end of the multi-label classifier 1320 may correspond to an object category. For example, output end 1 may represent car, output end 2 may represent bicycle, output end 3 may represent pedestrian, etc. Assuming that a count of number of the output ends of the multi-label classifier 1320 are k, the i-th sample label of the i-th source domain training sample may be yᵢ^{s}ϵ{0,1}^{k}.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 5 is a flowchart illustrating an exemplary process for training a training model according to some embodiments of the present disclosure.

The adversarial unit 133 may include a feature processing sub-unit (e.g., a convolutional network), a connection sub-unit, and a prediction layer. More descriptions about the adversarial unit 133 may be found elsewhere in the present disclosure (e.g., FIG. 6 and the descriptions thereof).

In some embodiments, the second processing unit 134 may include a region convolutional neural network (RCNN). As used herein, the RCNN refers to a special neural network for object detection or feature recognition, which can reflect object categories included in image data (i.e., images). Thus, the source domain training data 110 and the target domain training data 120 are images.

In some embodiments, the second processing unit 134 may use the RCNN as the detection network. The output ends of the RCNN may include a classification end and a regression end. In some embodiments, the second processing unit 134 may also include a region proposal network (RPN), a candidate region, a region of interest (ROI), etc. The RPN may be a fully-convolutional network that simultaneously predicts object bounds and object scores at each position. In some embodiments, the RPN may be trained end-to-end to generate high-quality region proposals, which are used by the RCNN (e.g., a Fast R-CNN) for detection. With a simple alternating optimization, the RPN and the RCNN can be trained to share convolutional features. Thus, the RPN may share full-image convolutional features with the RCNN, enabling nearly cost-free region proposals.

The regression end may be configured to determine a position of each object in the images. In some embodiments, the regression end may be realized based on a bounding-box regression algorithm.

The classification end may be configured to determine a category of each object in the images. For example, the classification end may output judgment results and/or probability values of the category of the objects in the images. For instance, when a specific object in an image is recognized as a car, the classification end may output a probability value of 0.96 that the specific object is a car.

In some embodiments, the regression end may relate to a regression loss function L_{reg}, and the classification end may relate to a classification loss function L_{cls}. In some embodiments, the regression loss function and the classification loss function may be generated and/or adjusted according to actual situations (e.g., algorithm(s) and model(s) actually used), which is not limited in the present disclosure.

In some embodiments, a fourth loss function may be determined based on the regression loss function L_{reg} and the classification loss function L_{cls}. For example, the fourth loss function may be determined based on a sum of the regression loss function L_{reg} and the classification loss function L_{cls}, which may be represented as Equation (3):

L_{det}=L_{cls}+L_{reg} (3)

As another example, the regression loss function L_{reg} and the classification loss function L_{cls} may be assigned weights, and the fourth loss function may be determined based on the weights. In some embodiments, the weights of the two loss functions may be preset (e.g., by a user via a terminal device) to reflect the importance of the regression loss function L_{reg} and the classification loss function L_{cls} during the training. The fourth loss function may represent the detection loss of the second processing unit 134, which may further be used for training of the training model 130.

In some embodiments, the training model 130 may be trained based on the first loss function 210, the second loss function 220, the third loss function 230, and the fourth loss function. In such cases, the total loss function of the training model 130 may be represented as Equation (4):

Lₐₗₗ=L_{det}+λL_{adv}+μLₘᵤₗₜᵢ+εLₖₗ (4)

where L_{adv} denotes the second loss function 220, λ, μ, and ε denote weights for the corresponding loss functions.

After the training model 130 is trained based on the first loss function 210, the second loss function 220, the third loss function 230, and the fourth loss function, a trained model may be generated by updating one or more parameters of the training model 130 to make the source prediction domains 173 output by the trained model approach the target prediction domains 183, enable the feature extraction unit 131 to obtain the commonalities of different domains as much as possible when extracting features, and reduce the influence of differences between domains.

The trained model may be used to predict data of the target domain. The data used in prediction can be different from the data used in training. The prediction may be performed based on an updated feature extraction unit, an updated first processing unit, and an updated second processing unit of the trained model.

It should be noted that by training the training model 130 in the above described manner, the total loss function of the training model 130 may include both loss values of object positions in the image data generated by the regression end and loss values of object categories in the image data generated by the classification end, which are optimized in the joint training.

By optimizing the fourth loss function, the features extracted from the source domain training data and the target domain training data by the feature extraction unit may be aligned, which is beneficial to predict the features in the unlabeled target domain data.

Further, since both the first processing unit and the second processing unit can output source prediction outputs based on source features extracted by the features extraction unit, and the source features and the target features extracted by the features extraction unit may have strong domain commonalities, the updated first processing unit and the updated second processing unit of the trained model may output accurate prediction results for the data in the target domain.

In this way, when the target domain data lacks sufficient sample labels, a model with strong predictive ability for the target domain can be trained using the labeled sample data in the source domain and the unlabeled sample data in the target domain.

In order to test the trained model proposed in the present disclosure (“MCAR model” for brevity), the MCAR model is compared with the source-only baseline and adaptive object detection techniques, including BDC-Faster, DA-Faster, and SW-DA. Test results of domain adaptation for object detection from PASCAL VOC to Watercolor in terms of mean average precision (mAP, %) are described in Table 1, wherein MC and PR indicate Multi-label Conditional adversarial and Prediction based Regularization, respectively. The Train-on-Target results, obtained by training on labeled data in the target domain, are also provided as upper-bound reference values.

TABLE 1
Test results of domain adaptation for object detection from PASCAL
VOC to Watercolor in terms of mean average precision (%)

| Method | MC | PR | bike | bird | car | cat | dog | person | mAP |
|---|---|---|---|---|---|---|---|---|---|
| Source-only | | | 68.8 | 46.8 | 37.2 | 32.7 | 21.3 | 60.7 | 44.6 |
| BDC-Faster | | | 68.6 | 48.3 | 47.2 | 26.5 | 21.7 | 60.5 | 45.5 |
| DA-Faster | | | 75.2 | 40.6 | 48.0 | 31.5 | 20.6 | 60.0 | 46.0 |
| SW-DA | | | 82.3 | 55.9 | 46.5 | 32.7 | 35.5 | 66.7 | 53.3 |
| MCAR | √ | | 92.5 | 52.2 | 43.9 | 46.5 | 28.8 | 62.5 | 54.4 |
| | √ | √ | 87.9 | 52.1 | 51.8 | 41.6 | 33.8 | 68.8 | 56.0 |
| Train-on-Target | | | 83.6 | 59.4 | 50.7 | 43.7 | 39.5 | 74.5 | 58.6 |

Moreover, the results of adaptation from PASCAL VOC to Comic are reported in Table 2.

TABLE 2
Test results of domain adaptation for object
detection from PASCAL VOC to Comic

| Method | MC | PR | bike | bird | car | cat | dog | person | mAP |
|---|---|---|---|---|---|---|---|---|---|
| Source-only | | | 32.5 | 12.0 | 21.1 | 10.4 | 12.4 | 29.9 | 19.7 |
| DA-Faster | | | 31.1 | 10.3 | 15.5 | 12.4 | 19.3 | 39.0 | 21.2 |
| SW-DA | | | 36.4 | 21.8 | 29.8 | 15.1 | 23.5 | 49.6 | 29.4 |
| Train-on-Target | √ | | 40.9 | 22.5 | 30.3 | 23.7 | 24.7 | 53.6 | 32.6 |
| | √ | √ | 47.9 | 20.5 | 37.4 | 20.6 | 24.5 | 50.2 | 33.5 |

In some embodiments, adaptive object detection from normal clear images to foggy images based on the MCAR model may be performed. The Cityscapes dataset is used as the source domain data, which come from different urban scenes, the Foggy Cityscapes dataset is used as the target domain data, wherein the results are reported in the Table 3.

TABLE 3
Test results of domain adaptation for object detection
from Cityscapes to Foggy Cityscapes in terms of mAP (%)

| Method | MC | PR | person | rider | car | truck | bus | train | motorbike | bicycle | mAP |
|---|---|---|---|---|---|---|---|---|---|---|---|
| Source-only | | | 25.1 | 32.7 | 31.0 | 12.5 | 23.9 | 9.1 | 23.7 | 29.1 | 23.4 |
| BDC-Faster | | | 26.4 | 37.2 | 42.4 | 21.2 | 29.2 | 12.3 | 22.6 | 28.9 | 27.5 |
| DA-Faster | | | 25.0 | 31.0 | 40.5 | 22.1 | 35.3 | 20.2 | 20.0 | 27.1 | 27.6 |
| SC-DA | | | 33.5 | 38.0 | 48.5 | 26.5 | 39.0 | 23.3 | 28.0 | 33.6 | 33.8 |
| MAF | | | 28.2 | 39.5 | 43.9 | 23.8 | 39.9 | 33.3 | 29.2 | 33.9 | 34.0 |
| SW-DA | | | 36.2 | 35.3 | 43.5 | 30.0 | 29.9 | 42.3 | 32.6 | 24.5 | 34.3 |
| DD-MRL | | | 30.8 | 40.5 | 44.3 | 27.2 | 38.4 | 34.5 | 28.4 | 32.2 | 34.6 |
| MTOR | | | 30.6 | 41.4 | 44.0 | 21.9 | 38.6 | 40.6 | 28.3 | 35.6 | 35.1 |
| Dense-DA | | | 33.2 | 44.2 | 44.8 | 28.2 | 41.8 | 28.7 | 30.5 | 36.5 | 36.0 |
| MCAR | √ | | 31.2 | 42.5 | 43.8 | 32.3 | 41.1 | 33.0 | 32.4 | 36.5 | 36.6 |
| | √ | √ | 32.0 | 42.1 | 43.9 | 31.3 | 44.1 | 43.4 | 37.4 | 36.6 | 38.8 |
| Train-on-Target | | | 50.0 | 36.2 | 49.7 | 34.7 | 33.2 | 45.9 | 37.4 | 35.6 | 40.3 |

According to Tables 1 to 3, compared with other existing models, the model proposed in the present disclosure (i.e., the MCAR model) may achieve goad adaptive detection results.

In some embodiments, to investigate the impact of loss components including a first loss (also referred to as a multi-label prediction loss, e.g., Lₘᵤₜᵢₗ in Equation (1)), a second loss (also referred to as a conditional adversary loss, e.g., L_{adv} in Equation (7)), and a third loss (also referred to as a prediction regularization loss, e.g., Lₖₗ in Equation (2)), a more comprehensive ablation study may be conducted on the adaptive detection task from Cityscapes to Foggy Cityscapes by comparing the MCAR model with its multiple variants. The variant methods and results are reported in Table 4, wherein “w/o-adv” indicates dropping the conditional adversary loss; “uadv” indicates replacing the conditional adversary loss with an unconditional adversary loss; “w/o-PR” indicates dropping the prediction regularization loss; and “w/o-MP-PR” indicates dropping both the multi-label prediction loss and the prediction regularization loss.

TABLE 4
The ablation study results in terms of mAP (%) on the adaptive
detection task of Cityscapes to Foggy Cityscapes

| Method | person | rider | car | truck | bus | train | motorbike | bicycle | mAP |
|---|---|---|---|---|---|---|---|---|---|
| MCAR | 32.0 | 42.1 | 43.9 | 31.3 | 44.1 | 43.4 | 37.4 | 36.6 | 38.8 |
| MCAR-w/o-PR | 31.2 | 42.5 | 43.8 | 32.3 | 41.1 | 33.0 | 32.4 | 36.5 | 36.6 |
| MCAR-uadv | 31.7 | 42.0 | 45.7 | 30.4 | 39.7 | 14.9 | 28.6 | 36.5 | 33.7 |
| MCAR-uadv-w/o-PR | 32.8 | 40.1 | 43.8 | 23.0 | 30.9 | 14.3 | 30.3 | 33.1 | 31.0 |
| MCAR-uadv-w/o-MP-PR | 30.5 | 43.2 | 41.4 | 21.7 | 31.4 | 13.7 | 29.8 | 32.6 | 30.5 |
| MCAR-w/o-adv | 25.0 | 34.9 | 34.2 | 13.9 | 29.9 | 10.0 | 22.5 | 30.2 | 25.1 |

According to Tables 4, that dropping the conditional adversary loss (MCAR-w/o-adv) leads to large performance degradation. This makes sense since the conditional adversary loss is the foundation for cross-domain feature alignment. By replacing the conditional adversary loss with an unconditional adversary loss, MCAR-uadv loses the multi-label-conditional adversary (MC) component, which leads to remarkable performance degradation and verifies the usefulness of the multi-label prediction based cross-domain multi-modal feature alignment. Dropping the prediction regularization loss from either MCAR, which leads to MCAR-w/o-PR, or MCAR-uadv, which leads to MCAR-uadv-w/o-PR, induces additional performance degradation. This verifies the effectiveness of the prediction regularization strategy, which is built on the multi-label prediction outputs as well. Moreover, by further dropping the multi-label prediction loss from MCAR-uadv-w/o-PR, the variant MCAR-uadv-w/o-MP-PR's performance also drops slightly. Overall these results validated the effectiveness of the proposed MC and PR mechanisms, as well as the multiple auxiliary loss terms in the proposed learning objective.

In some embodiments, referring to the related descriptions in FIGS. 2 and 5, it should be noted that judgment results and/or probability values indicating the category of the objects outputted from the classification end based on the source features 170 may be the second source prediction outputs 182, and judgment results and/or probability values indicating the category of the objects outputted from the classification end based on the target features 180 may be the second target prediction outputs 172. In some embodiments, the second source prediction outputs 172 and the second target prediction outputs 182 may be the same as the first source prediction outputs 171 and the first target prediction outputs 181 outputted by the first processing unit 132, for example, both first prediction outputs and the second prediction outputs are same probability values. Thus, the loss function Lₖₗ^{s} in Equation (2) may be determined based on the first source prediction outputs 171 and the second source prediction outputs 172, and the loss function Lₖₗ^{t} in Equation (2) may be determined based on the first target prediction outputs 181 and the second target prediction outputs 182.

In some embodiments, an index that can reflect the difference between two probability distributions (i.e., differences between the first source prediction outputs and the second source prediction outputs, or the divergences between the first target prediction outputs and the second target prediction outputs) may include KL divergence, JS divergence, Wasserstein distance, or the like, or any combination thereof. The KL divergence may also be referred to as relative entropy, which is an asymmetric measure of a difference between two probability distributions. In some embodiments, the KL divergence may be used as a loss function for optimization algorithms. In some embodiments, when the KL divergence is selected to reflect the difference between two sets of probability values of the outputs of the first processing unit and the outputs of the classification end, the loss function Lₖₗ^{s} may be represented as Equation (5), and the loss function Lₖₗ^{t} may be represented as Equation (6):

$$\begin{matrix}{L}_{kl}^{s} = \frac{1}{2 {n}_{s}} {\sum }_{i = 1}^{{n}_{s}} ( KL ( {p}_{i}^{s} , {q}_{i}^{s} ) + KL ( {q}_{i}^{s} , {p}_{i}^{s} ) ) & ( 5 ) \\ {L}_{kl}^{t} = \frac{1}{2 {n}_{s}} {\sum }_{i = 1}^{{n}_{t}} ( KL ( {p}_{i}^{t} , {q}_{i}^{t} ) + KL ( {q}_{i}^{t} , {p}_{i}^{t} ) ) & ( 6 )\end{matrix}$$

where Lₖₗ^{s} denotes the source divergence loss function, Lₖₗ^{t} denotes the target divergence loss function, nₛ denotes a sample count of the source domain training samples 110, nₜ denotes a sample count of the target domain training samples 120, pᵢ^{s} denotes the i-th first source prediction output, pᵢ^{t} denotes the i-th first target prediction output, qᵢ^{s} denotes the i-th second source prediction output, and gᵢ^{t} denotes the i-th second target prediction output.

In some embodiments, according to FIG. 3 and Equation (3), and the descriptions thereof, the source divergence loss function and the target divergence loss function may be used to the training of the training model 130 by constructing the third loss function.

In some embodiments, the source domain training data 110 and the target domain training data 120 may be text data. The feature extraction unit 131 may extract the source features 170 and the target features 180 based on the source domain training data 110 and the target domain training data 120 according to a language model.

In some embodiments, the feature extraction unit 131 may include a paragraph vector model (e.g., Doc2vec), by which the features of the source domain training data 110 are extracted to obtain the source features 170, and the features of the target domain training data 120 are extracted to obtain the target features 180. In some embodiments, the first processing unit 132 may include a BERT model. The first processing unit 132 may be used to reflect semantic categories included in the text data. In such cases, the first source prediction outputs 171 and first target prediction outputs 181 may be the classification results of semantic categories.

It should be noted that whether the training data is text data, image data, or any other forms of data (e.g., audio data), the purpose of the machine learning model training methods based on cross-domain data as described in the present disclosure is to training the training model 130 (i.e., the initial machine learning model as described in FIG. 1) by updating one or more parameters of the training model 130 to make the source prediction domains 173 output by the trained model approach the target prediction domains 183, enable the feature extraction unit 131 to obtain the commonalities of different domains as much as possible when extracting features, and reduce the influence of differences between domains.

FIG. 6 is a flowchart illustrating an exemplary process for training a training model according to some embodiments of the present disclosure.

In some embodiments, the adversarial unit 133 may include a feature processing sub-unit 1331, a connection sub-unit 1332, and a prediction layer 1333.

The feature processing sub-unit 1331 may be configured to determine multiple source sub-features 175 by processing the plurality of source features 170, and determine multiple target sub-features 185 by processing the plurality of target features 180. In some embodiments, the feature processing sub-unit 1331 may include a convolutional network. The feature processing sub-unit 1331 may further extract features of the source features 170 and the target features 180, and output the source sub-features 175 and the target sub-features 185.

The connection sub-unit 1332 may be configured to combine the source sub-features 175 with the first source prediction outputs 171, and combine the target sub-features 185 with the first target prediction outputs 181. For example, the connection sub-unit 1332 may multiply the source sub-features 175 with the first source prediction outputs 171, and multiply the target sub-features 185 with the first target prediction outputs 181.

The prediction layer 1333 may be configured to generate multiple prediction results (including the source prediction domains 173 and the target prediction domains 183) based on outputs (including source outputs and target outputs) of the connection sub-unit 1332. In some embodiments, the prediction layer 1333 may include input layers corresponding to the dimension of the outputs of the connection sub-unit 1332. The multi-dimensional data may be converted into first prediction outputs by the prediction layer 1333. In some embodiments, the outputs (or first prediction outputs) of the prediction layer 1333 may be probability values. In some embodiments, the outputs of the prediction layer 1333 may be prediction results directly output by setting an activation function on the output layer. More descriptions regarding the outputs of the adversarial unit 133 may be described in connection with FIG. 2.

In some embodiments, the training model 130 may further include a gradient reversal layer (GRL). The GRL may be used between the feature extraction unit 131 and the adversarial unit 133 to achieve across-domain feature alignment. Through the GRL, the gradient inversion during a back propagation process may be realized, thereby constructing a confrontation loss similar to the GAN and avoiding the two-stage training process of GAN.

With reference to the descriptions in FIG. 2, the source domain loss function and the target domain loss function may be constructed separately, and the second loss function 220 may be determined by the source domain loss function and the target domain loss function. In some embodiments, the second loss function 220 may be determined as Equation (7) as follows:

$${min}_{F} {max}_{D} {L}_{adv} = - \frac{1}{2} ( {L}_{adv}^{s} + {L}_{adv}^{t} ) \qquad ( 7 )$$

where L_{adv} denotes the second loss function 220, L_{adv} denotes an adversarial loss function in the source domain, and L_{adv}^{t} denotes an adversarial loss function in the target domain, wherein L_{adv}^{s} may be represented as Equation (8) and L_{adv}^{t} may be represented as Equation (9):

$$\begin{matrix}{L}_{adv}^{s} = - \frac{1}{{n}_{s}} {\sum }_{i = 1}^{{n}_{s}} {( 1 - D ( F ( {x}_{i}^{s} ) , {P}_{i}^{s} ) )}^{γ} log ( D ( F ( {x}_{i}^{s} ) , {P}_{i}^{s} ) & ( 8 ) \\ {L}_{adv}^{t} = - \frac{1}{{n}_{t}} {\sum }_{i = 1}^{{n}_{t}} {( 1 - D ( F ( {x}_{i}^{t} ) , {P}_{i}^{t} ) )}^{γ} log ( 1 - D ( F ( {x}_{i}^{t} ) , {P}_{i}^{t} ) & ( 9 )\end{matrix}$$

where D(F(xᵢ^{s}), pᵢ^{s} denotes the i-th output of the feature processing sub-unit 1331 by multiplying the source sub-feature(s) and the first source prediction output(s), D(F(xᵢ^{t}), Pᵢ^{t}) denotes the i-th output of the feature processing sub-unit 1331 by multiplying the target sub-feature(s) and the first target prediction output(s), and γ denotes a modulation factor that controls how much to focus on the hard-to-classify sample.

During the training of the training model 130 based on the total loss function Lₐₗₗ as described in FIG. 5, in some embodiments, the parameters λ and γ may be analyzed according to the following description, wherein λ controls the weight of adversarial feature alignment, and γ controls the degree of focusing on hard-to-classify examples. Other parameters may be set to their default values. The experiment may be conducted by fixing the value of γ to adjust λ, and then fixing λ to adjust γ. The results may be presented in Table 5.

TABLE 5
Parameter sensitivity analysis on task of
adaptation from PASCAL VOC to watercolor

| λ | 0.5 | | | | |
|---|---|---|---|---|---|
| γ | 1 | 3 | 5 | 7 | 9 |
| mAP | 44.0 | 46.1 | 54.4 | 49.1 | 44.8 |
| γ | 5 | | | | |
| λ | 0.1 | 0.25 | 0.5 | 0.75 | 1 |
| mAP | 49.1 | 50.2 | 54.4 | 50.1 | 49.3 |

According to Table 5, with the decrease of parameter γ from its default value 5, the test performance degrades as the influence of the adversarial unit 133 (or a domain classifier) on difficult samples is weakened and the contribution of easy samples is increased. On the other hand, a very large γ value is not good either, as the most difficult samples will dominate. For λ, it can be found that λ=0.5 leads to the best performance. As detection is still the main task, it makes sense to have the λ<1. When λ=0, it degrades to a basic model without feature alignment (i.e., the training model has no the adversarial unit 133).

It should be noted that during the training of the training model 130, the training model may exploit multi-label prediction as an auxiliary dual task to reveal the object information in training data (e.g., object category information in each image) and then use the object information as an additional input to perform conditional adversarial cross-domain feature alignment. Such a conditional feature alignment may be expected to improve the discriminability of the features while bridging the cross-domain representation gaps to increase the transferability and domain invariance of features.

In some embodiments, after the training model 130 is trained (e.g., a prediction model is generated), the trained model may be used to predict actual data in target domain. Because both the first processing unit and the second processing unit can output source prediction outputs based on source features extracted by the features extraction unit, and the source features and the target features extracted by the features extraction unit may have strong domain commonalities, the updated first processing unit and the updated second processing unit of the trained model may output accurate prediction results for the target domain actual data.

In some embodiments, the trained model may include an updated first processing unit, an updated second processing unit, an updated feature extraction unit, and an updated adversarial unit.

Optionally, during the training of the training model 130, the second processing unit may be able to realize one or more functions that the first processing unit cannot realize (e.g., determining a position of each object in the images, etc.), and the second processing unit may learn characteristics of the first processing unit and the adversarial unit. Therefore, in some embodiments, the trained model may include the updated feature extraction unit and the updated second processing unit.

In some embodiments, the data of the target domain (also referred to as target domain data) may be actual data. Actual target features may be obtained by the updated feature extraction unit based on the target domain actual data. That is, the trained feature extraction unit may extract features of the target domain actual data, and output actual target features. Further, the updated second processing unit may output actual target prediction outputs based on the actual target features. The actual target prediction outputs may reflect actual prediction results of the actual data.

It should be noted that during the training, the feature extraction unit 131 may be trained to obtain the commonalities of different domains as much as possible when extracting features to reduce the influence of differences between domains. Therefore, the trained model may be difficult to distinguish whether the features come from the source domain or the target domain, that is, the features can still be extracted by the feature extraction unit regardless of whether the feature is previously labeled. As a result, during the prediction, the trained model may output accurately prediction results for data in the target domain.

In some embodiments, the target domain actual data may be real images acquired by an image acquisition device (e.g., a camera). In some embodiments, the target domain actual data may be data obtained in real-time or frequently updated. In some embodiments, the data in the source domain may also be real image data, wherein the features of the data in the source domain are labeled, and the features of the data in the target domain are unlabeled. By aligning features of the labeled data in the source domain and features of the unlabeled features in the target domain, the trained (or updated) feature extraction unit may extract unlabeled features in the target domain for further processing (e.g., category recognition).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Per, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

What is claimed is:

1. A system, comprising:
at least one storage device storing executable instructions, and
at least one processor in communication with the at least one storage device, when executing the executable instructions, causing the system to perform operations including:
obtaining multiple source domain training samples and multiple target domain training samples, wherein the multiple source domain training samples include multiple sample labels;
obtaining an initial machine learning model that includes a feature extraction unit, a first processing unit, and an adversarial unit, wherein the first processing unit is associated with a first loss function, and the adversarial unit is associated with a second loss function; and
generating, based on a total loss function relating to the first loss function and the second loss function, a trained machine learning model by training the initial machine learning model using the multiple source domain training samples and the multiple target domain training samples, wherein during the training,
the feature extraction unit extracts a plurality of source features of the multiple source domain training samples and a plurality of target features of the multiple target domain training samples;
the first processing unit determines multiple first source prediction outputs based on the plurality of source features and determines multiple first target prediction outputs based on the plurality of target features, wherein the multiple first source prediction outputs and the multiple sample labels are used to determine the first loss function; and
the adversarial unit determines multiple source prediction domains based on the plurality of source features and determines multiple target prediction domains based on the plurality of target features, wherein the multiple source prediction domains, domain labels of the multiple source domain training samples, the multiple target prediction domains, and domain labels of the multiple target domain training samples are used to determine the second loss function.

2. The system of claim 1, wherein the initial machine learning model further includes a second processing unit, and during the training, the second processing unit determines multiple second source prediction outputs based on the plurality of source features and determines multiple second target prediction outputs based on the plurality of target features, wherein:
the multiple first source prediction outputs, the multiple first target prediction outputs, the multiple second source prediction outputs, and the multiple second target prediction outputs are used to determine a third loss function that reflects a consistency of the first processing unit and the second processing unit, and
the at least one processor is further configured to cause the system to perform additional operations including:
training the initial machine learning model based on the third loss function.

3. The system of claim 2, wherein the multiple source domain training samples and the multiple target domain training samples are images, and
the second processing unit includes a region convolutional neural network (RCNN) that determines a category of each object included in the images.

4. The system of claim 3, wherein the RCNN includes a classification end that determines a position of each object in the images and a regression end that determines a category of each object in the images, the regression end relates to a regression loss function, and the classification end relates to a classification loss function, wherein the regression loss function and the classification loss function are used to determine a fourth loss function, and
the at least one processor is further configured to cause the system to perform additional operations including:
training the initial machine learning model based on the fourth loss function.

5. The system of claim 2, wherein to determine, based on the multiple first source prediction outputs, the multiple first target prediction outputs, the multiple second source prediction outputs, and the multiple second target prediction outputs, the third loss function, the at least one processor is further configured to cause the system to perform operations including:
determining, based on the multiple first source prediction outputs and the multiple second source prediction outputs, a source divergence loss function;
determining, based on the multiple first target prediction outputs and the multiple second target prediction outputs, a target divergence loss function; and
determining, based on the source divergence loss function and the target divergence loss function, the third loss function.

6. The system of claim 1, wherein the multiple source domain training samples and the multiple target domain training samples are images, wherein during the training, the feature extraction unit extracts the plurality of source features and the plurality of target features based on the multiple source domain training samples and the multiple target domain training samples according to a convolutional network.

7. The system of claim 6, wherein the first processing unit determines a category of each object included in the images, and the first processing unit includes a multi-label classifier having one or more label prediction output ends each of which corresponds to one category.

8. The system of claim 1, wherein the multiple target domain training samples and the multiple source domain training samples are text data, wherein during the training,
the feature extraction unit extracts the plurality of source features and the plurality of target features based on the multiple source domain training samples and the multiple target domain training samples according to a language model; and
the first processing unit determines at least a semantic category included in the text data.

9. The system of claim 1, wherein the adversarial unit includes:
a feature processing sub-unit configured to determine multiple source sub-features by processing the plurality of source features, and determine multiple target sub-features by processing the plurality of target features;
a connection sub-unit configured to determine multiple source outputs based on the multiple source sub-features and the multiple first source prediction outputs, and determine multiple target outputs based on the multiple target sub-features and the multiple first target prediction outputs; and
a prediction layer configured to generate multiple prediction results based on the multiple source outputs and the multiple target outputs.

10. The system of claim 2, wherein the at least one processor is further configured to cause the system to perform additional operations including:
extracting, by the feature extraction unit, one or more actual target features of target domain actual data; and
determining, by the second processing unit, one or more actual prediction results of the target domain actual data based on the one or more actual target features.

11. A method implemented on a computing device including at least one processor and at least one storage medium, and a communication platform connected to a network, the method comprising:
obtaining multiple source domain training samples and multiple target domain training samples, wherein the multiple source domain training samples include multiple sample labels;
obtaining the initial machine learning model that includes a feature extraction unit, a first processing unit, and an adversarial unit, wherein the first processing unit is associated with a first loss function, and the adversarial unit is associated with a second loss function; and
generating, based on a total loss function relating to the first loss function and the second loss function, a trained machine learning model by training the initial machine learning model using the multiple source domain training samples and the multiple target domain training samples, wherein during the training,
the feature extraction unit extracts a plurality of source features of the multiple source domain training samples and a plurality of target features of the multiple target domain training samples;
the first processing unit determines multiple first source prediction outputs based on the plurality of source features and determines multiple first target prediction outputs based on the plurality of target features, wherein the multiple first source prediction outputs and the multiple sample labels are used to determine the first loss function; and
the adversarial unit determines multiple source prediction domains based on the plurality of source features and determines multiple target prediction domains based on the plurality of target features, wherein the multiple source prediction domains, domain labels of the multiple source domain training samples, the multiple target prediction domains, and domain labels of the multiple target domain training samples are used to determine the second loss function.

12. The method of claim 11, wherein the initial machine learning model further includes a second processing unit, and during the training, the second processing unit determines multiple second source prediction outputs based on the plurality of source features and determines multiple second target prediction outputs based on the plurality of target features, wherein:
the multiple first source prediction outputs, the multiple first target prediction outputs, the multiple second source prediction outputs, and the multiple second target prediction outputs are used to determine a third loss function that reflects a consistency of the first processing unit and the second processing unit, and
the method, further comprising:
training the initial machine learning model based on the third loss function.

13. The method of claim 12, wherein the multiple source domain training samples and the multiple target domain training samples are images, and
the second processing unit includes a region convolutional neural network (RCNN) that determines a category of each object included in the images.

14. The method of claim 13, wherein the RCNN includes a classification end that determines a position of each object in the images and a regression end that determines a category of each object in the images, the regression end relates to a regression loss function, and the classification end relates to a classification loss function, wherein the regression loss function and the classification loss function are used to determine a fourth loss function, and
the method, further comprising:
training the initial machine learning model based on the fourth loss function.

15. The method of claim 12, wherein the determining, based on the multiple first source prediction outputs, the multiple first target prediction outputs, the multiple second source prediction outputs, and the multiple second target prediction outputs, the third loss function includes:
determining, based on the multiple first source prediction outputs and the multiple second source prediction outputs, a source divergence loss function;
determining, based on the multiple first target prediction outputs and the multiple second target prediction outputs, a target divergence loss function; and
determining, based on the source divergence loss function and the target divergence loss function, the third loss function.

16. The method of claim 11, wherein the multiple source domain training samples and the multiple target domain training samples are images, wherein during the training, the feature extraction unit extracts the plurality of source features and the plurality of target features based on the multiple source domain training samples and the multiple target domain training samples according to a convolutional network.

17. The method of claim 16, wherein the first processing unit determines a category of each object included in the images, and the first processing unit includes a multi-label classifier having one or more label prediction output ends each of which corresponds to one category.

18. The method of claim 11, wherein the multiple target domain training samples and the multiple source domain training samples are text data, wherein during the training,
the feature extraction unit extracts the plurality of source features and the plurality of target features based on the multiple source domain training samples and the multiple target domain training samples according to a language model; and
the first processing unit determines at least a semantic category included in the text data.

19. The method of claim 11, wherein the adversarial unit includes:
a feature processing sub-unit configured to determine multiple source sub-features by processing the plurality of source features, and determine multiple target sub-features by processing the plurality of target features;
a connection sub-unit configured to determine multiple source outputs based on the multiple source sub-features and the multiple first source prediction outputs, and determine multiple target outputs based on the multiple target sub-features and the multiple first target prediction outputs; and
a prediction layer configured to generate multiple prediction results based on the multiple source outputs and the multiple target outputs.

20. A non-transitory computer readable medium, comprising at least one set of instructions, wherein when executed by one or more processors of a computing device, the at least one set of instructions causes the computing device to perform a method, the method comprising:
obtaining multiple source domain training samples and multiple target domain training samples, wherein the multiple source domain training samples include multiple sample labels;
obtaining the initial machine learning model that includes a feature extraction unit, a first processing unit, and an adversarial unit, wherein the first processing unit is associated with a first loss function, and the adversarial unit is associated with a second loss function; and
generating, based on a total loss function relating to the first loss function and the second loss function, a trained machine learning model by training the initial machine learning model using the multiple source domain training samples and the multiple target domain training samples, wherein during the training,
the feature extraction unit extracts a plurality of source features of the multiple source domain training samples and a plurality of target features of the multiple target domain training samples;
the first processing unit determines multiple first source prediction outputs based on the plurality of source features and determines multiple first target prediction outputs based on the plurality of target features, wherein the multiple first source prediction outputs and the multiple sample labels are used to determine the first loss function; and
the adversarial unit determines multiple source prediction domains based on the plurality of source features and determines multiple target prediction domains based on the plurality of target features, wherein the multiple source prediction domains, domain labels of the multiple source domain training samples, the multiple target prediction domains, and domain labels of the multiple target domain training samples are used to determine the second loss function.
